(19) United States
(12) Patent Application Publication
(10) Pub. No.: US 2021/0254650 A1
(43) Pub. Date: Aug. 19, 2021

(54) DEFORMED BLIND RIVET LOOP CLAMP

(71) Applicant: ELLIOTT GREENFIELD, RYDAL, PA (US)

(72) Inventor: ELLIOTT GREENFIELD, RYDAL, PA (US)

(21) Appl. No.: 16/792,257

(22) Filed: Feb. 16, 2020

(51) Int. Cl. F16B 13/06; F16B 37/06; F16L 3/14

(52) U.S. Cl. CPC F16B 13/061; F16B 2200/506; F16L 3/14; F16B 37/067

(57) ABSTRACT

A pipe or tube hanger consisting of a loop clamp combined with a blind rivet fastener which has the joint deformed to stiffen the blind rivet so it may be used as a tension member in the application. This will replace cast iron parts which have been typically used for this application. See FIG. 1. Because of air pollution many small cast iron foundries no longer operate in the United States. This novel methodology also eliminates weld joining of the two parts which requires post plating to restore cladding or galvanizing or post painting of the parts. Using this mechanical joint enables the use of pre-painted or galvanized material and allows fully finished parts to exit the automated fabricating process and go directly into shipping containers dramatically reducing handling and reducing the customers costs and making domestic manufacturing of the product competitively possible.

### BACKGROUND OF THE INVENTION AND PRIOR ART

Ring hangers for tubular sections as shown in FIG. 1 have long been made in various styles from castings or forgings. The method presented here enables a common blind rivet element to be used as the threaded element in a sheet metal loop clamp assembly as shown in FIG. 4.

In his patent application #160486 dated Jun.10, 2004 to the Japanese patent office, Katsumi Morishima described and illustrated a deformed bead on a blind rivet nut after its installation. Morishima noted that his invention which was for a shaped anvil would enable the blind rivet nut to more closely follow the surface to which is was attached. He was unaware that this same deformation gives the blind rivet nut new, novel and useful purpose. Morishima made no reference in his patent application that by deforming the bulged area of the rivet nut after the installation that there would be new mechanical properties and new and novel uses for the blind rivet nut. The Patent application presented here distinguishes itself over the Morishima Patent application by taking advantage of the mechanical stiffness afforded by that deformation to the bulged area. The deformation enables the rivet to be used in reverse of its originally intended direction and in that reverse direction it can be used as the threaded component of a suspension loop hanger. So even though Morishima showed a deformation, he neither showed nor discussed its use in preventing the rivet nut from being pulled back to its pre-compressed or pre-bulged state. This new and novel use is presented here. This application then presents a whole new use for the blind rivet nut. It represents a new product in the marketplace and a new cost effective replacement for old cast iron split ring hangers.

This method enables pre-plated or coated stock to be used as no welding is required for assembly. The blind rivet nuts are a standard commercial plated product and as such available at low cost. By not having to do secondary post processes to the assembled product, the item may be packaged directly off an automated manufacturing assembly line eliminating the added costs of handling and transport.

### (1) Field of the Invention

The invention presented is for use in building construction for both electrical and plumbing applications to hang wire, cables, tubing and pipes typically from threaded rods.

### Brief Summary of the Invention

This invention uses a blind rivet nut as the threaded element of a suspension loop clamp.

The invention is made by forming a loop clamp in a circle with the ends bent radially to the center of the loop. A generally round hole is punched into the loop using a press and industry standard round punch and button tooling. A blind rivet nut is then inserted from the inside the loop clamp through the punched hole. The blind rivet nut is then collapsed under compression axially to its thread to form a bulged portion. This bulged portion is then further deformed by applying pressure with a shaped cylindrical tool to the bulged portion again axially to the thread of the blind rivet nut. A fastener is then inserted into the holes of the loop clamp to complete the assembly. See FIG. 4.

The problem with using the blind rivet nut loaded in the opposite direction for which it was originally intended is the resistance of the formed bulged section to be uncompressed and stretched back to its original shape as the blind rivet nut is being loaded pulled in this reverse direction.

The object of the present invention is to increase the yield strength of the compressed blind rivet nut so that it may be successfully used as the threaded component of a loop clamp. Deforming the blind rivet nut bulge increases its resistance to unbending. The increased resistance is dependent on the shape and type of the deformation. Many types of deformations are possible to make the resulting bead and joint non-planar.

The novel use of the deformed blind rivet nut enables a low cost loop clamp to replace many present imported castings.

The loop clamp is often attached using all thread rod (3) as shown in FIG. 4. The blind rivet nut may also be ribbed on its mating surfaces to increase its resistance to being torqued out of the connection

Examples of possible non-planar deformations are shown in FIG. 5 and FIG. 6 as a conical deformation, or FIG. 3 as a bending deformation showing the loop (1) attached to the blind rivet element (2). FIG. 7 shows the blind rivet element with a radial ripple shaped deformation. Many other deformations are possible which make the compressed joint non-planar.

The invention is depicted using a plurality of embodiments in an exemplary manner without being limited thereto.

### BRIEF DESCRIPTION OF THE SEVERAL VIEWS OF THE DRAWING(S)

FIG. 1. shows prior art and is a cast loop clamp, commonly known as a split ring hanger.

FIG. 2. shows a side view of an assembled loop clamp.

FIG. 3. shows a cross section view of loop clamp showing blind rivet insert element (2) deformed about the loop clamp (1). No fastener is shown.

FIG. 4. shows a deformed blind rivet loop clamp with a suspension threaded rod (3), a blind insert element having a cylindrical shaped deformation (2), and the attached loop clamp (1) with its associated fastener (4).

FIG. 5. shows a blind rivet element with a conical shaped deformation.

FIG. 6 shows a cross section of blind rivet element with a conical shaped deformation.

FIG. 7. shows a blind rivet element with a ripple shaped deformation.

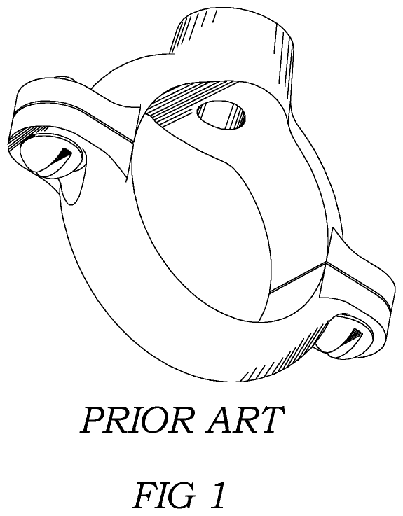

### DETAILED DESCRIPTION OF THE INVENTION

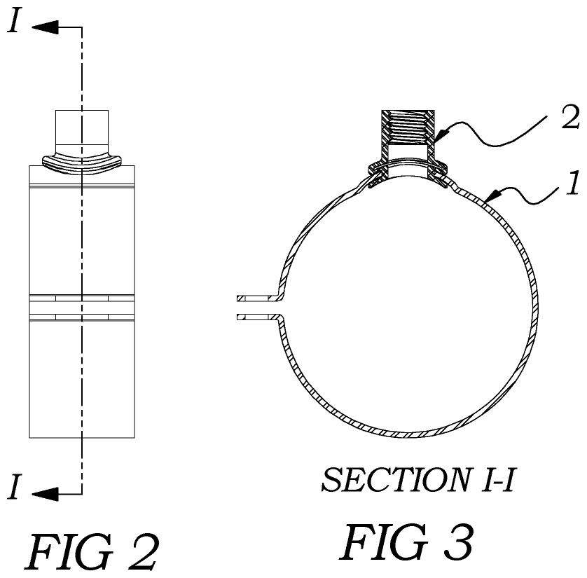

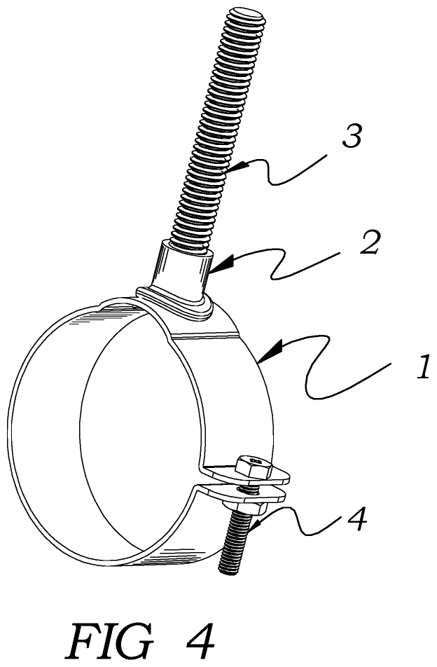

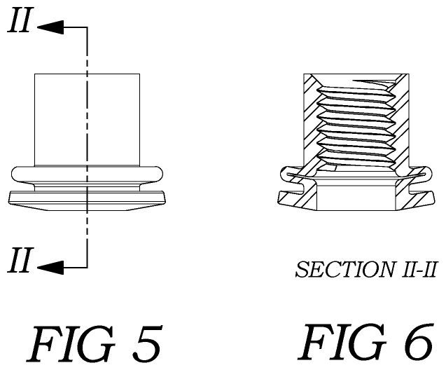

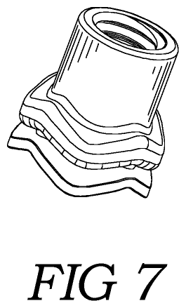

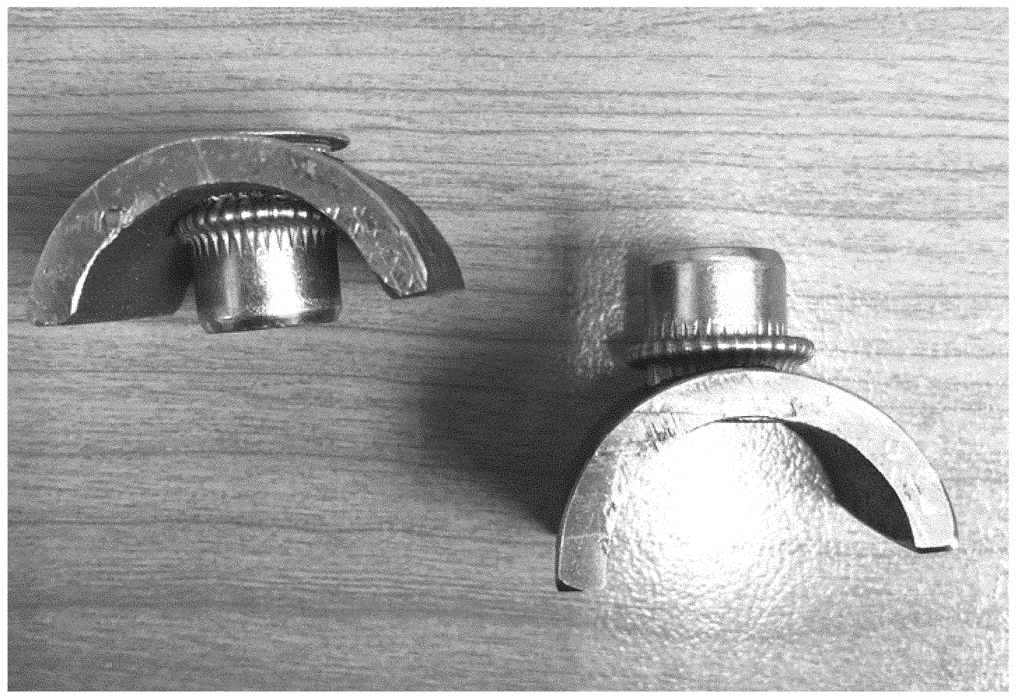

A suspension loop clamp which consists of a blind rivet element that includes a setting head attached to one head of a shank that is smaller in diameter than the setting head and has an opposite end with an internal female thread or a receptacle for a threaded rod as well as a deformation section disposed axially there between and a strip of flat material. The blind rivet nut (FIG. 3 part 2) is inserted into the flat strip through a hole in the loop. The blind rivet is then plastically deformed by compression axially applied to both ends of the blind rivet by flat plates opposed to each other from an unset condition to a set condition collapsing it and forming a radially outwardly protruding bulge or bead, which serves to retain the blind rivet element to the loop. The loop clamp is a strip of sheet material, preferably metal but not exclusively such which has bends at each end and a fastener aperture at each end. See FIG. 2. The blind rivet element flange and bead and the loop clamp it is attached to are then deformed together through axial compression applied to just the bead and flange by a tool which is hollow and shaped to allow the tubular section of the blind rivet nut to slip inside so the bulged portion of the collapsed rivet nut may be deformed so the bead at this juncture is no longer planar. The final deformation is to the clamp loop as well as the bead and flange of the blind rivet nut. This stiffens the protruding bead so as to restrict the blind rivet from reverting back to its original shape when a tensile load is applied by a threaded rod attachment. See FIG. 4. It is this new ability of the blind rivet to resist the unbending when used as a tension member by means of the deformation process that is the novelty of this patent application. This may be accomplished in individual steps or combined through the use of delayed high pressure compression gas springs in a press. The gas spring compresses the blind rivet first and then the overriding mechanical force of a press deforms the bead.

The clamp loop thus created is used then to support cylindrical cross sectional members such as pipes or tubes using all thread rods. The clamp loop locks the cylindrical section generally perpendicular by means of a threaded fastener as shown in FIG. 4. The fastening may be applied as a bolt and nut as shown in FIG. 4 or by any alternative method.

### Statement:

This specification contains no new matter.

1. (canceled)

2. (canceled)

3. A method for assembling a suspension loop clamp consisting of a flanged blind rivet nut element and a clamp loop element and the said clamp loop element's associated fastener, where the said clamp loop element has an aperture within it through which the said flanged blind rivet nut element is inserted into the said loop clamp element from the inside of the loop and then the said blind rivet nut element is collapsed axially by a compression means to form a bulged section and then thereafter the collapsed bulged portion section of the compressed said blind rivet element is further deformed by a second shaped compression means, so as to make the said collapsed bulge portion of the blind rivet element be non-planar.

4. A suspension loop clamp produced using the method of claim 1.
